(19) United States
(12) Patent Application Publication
(10) Pub. No.: US 2025/0232095 A1
(43) Pub. Date: Jul. 17, 2025

(54) INFORMATION PROCESSING APPARATUS, METHOD, AND STORAGE MEDIUM

(71) Applicant: KABUSHIKI KAISHA TOSHIBA, Tokyo (JP)

(72) Inventors: Chenyuan XU, Kawasaki Kanagawa (JP); Masahiro OZAWA, Yokohama Kanagawa (JP)

(73) Assignee: KABUSHIKI KAISHA TOSHIBA, Tokyo (JP)

(21) Appl. No.: 19/014,920

(22) Filed: Jan. 9, 2025

(30) Foreign Application Priority Data
Jan. 11, 2024 (JP) 2024-002774

(51) Int. Cl. G06F 30/27; G06F 111/10

(52) U.S. Cl. CPC G06F 30/27; G06F 2111/10

(57) ABSTRACT

According to one embodiment, an information processing apparatus comprising a processor. The processor is configured to execute: first search processing of searching for a first provisional solution of a combinatorial optimization problem in which an objective function is partially differentiable, using a first search machine that solves an overall problem of the combinatorial optimization problem; and a second search processing of outputting a final solution of the combinatorial optimization problem based on a comparison between signs of the first provisional solution and a partial differential value of the objective function.

### CROSS-REFERENCE TO RELATED APPLICATIONS

This application is based upon and claims the benefit of priority from Japanese Patent Application No. 2024-002774, filed Jan. 11, 2024, the entire contents of which are incorporated herein by reference.

### FIELD

Embodiments described herein relate generally to an information processing apparatus, a method, and a storage medium.

### BACKGROUND

In order to solve a large-scale combinatorial optimization problem, there is a problem that an accurate solution cannot be obtained or an enormous processing time is required to obtain an accurate solution.

### BRIEF DESCRIPTION OF DRAWINGS

FIG. 1 is a diagram illustrating a hardware configuration example of an information processing apparatus.

FIG. 2 is a diagram illustrating a relationship between an Ising energy E_{ising} and a spin s.

FIG. 3 is a diagram illustrating by an example a processing procedure of optimization processing.

FIG. 4 is a diagram schematically illustrating a transition between a sign of a solution and a sign of partial differentiation in the optimization processing shown in FIG. 3.

FIG. 5 is a diagram for comparing prediction accuracy and the number of matching dimensions (incomplete optimization dimensions) in a case where a binary classification problem is solved by a simulated bifurcation machine.

FIG. 6 is a diagram for comparing prediction accuracy between the present embodiment and a comparative example in a case where a binary classification problem is solved by a simulated bifurcation machine (SB) and a simulated annealing machine (SA).

FIG. 7 is a diagram for comparing prediction accuracy between the present embodiment and a comparative example in a case where a linear regression problem is solved by a simulated bifurcation machine (SB) and a simulated annealing machine (SA).

FIG. 8 is a diagram for comparing prediction accuracy between the present embodiment and a comparative example in a case where a traveling salesman problem (gr96) is solved by a simulated bifurcation machine (SB) and a simulated annealing machine (SA).

FIG. 9 is a diagram for comparing prediction accuracy between the present embodiment and a comparative example in a case where a traveling salesman problem (ch130) is solved by a simulated bifurcation machine (SB) and a simulated annealing machine (SA).

FIG. 10 is a diagram illustrating by an example a processing procedure of optimization processing according to a modification.

FIG. 11 is a diagram schematically illustrating a transition between a sign of a solution and a sign of partial differentiation in the optimization processing shown in FIG. 10.

### DETAILED DESCRIPTION

An information processing apparatus according to an embodiment includes a first search unit and a second search unit. The first search unit searches for a first provisional solution of a combinatorial optimization problem in which an objective function is partially differentiable, using a first search machine that solves an overall problem of the combinatorial optimization problem. The second search unit outputs a final solution of the combinatorial optimization problem based on a comparison between signs of the first provisional solution and a partial differential value of the objective function.

Hereinafter, an information processing apparatus, a method, and a program according to the present embodiment will be described with reference to the drawings.

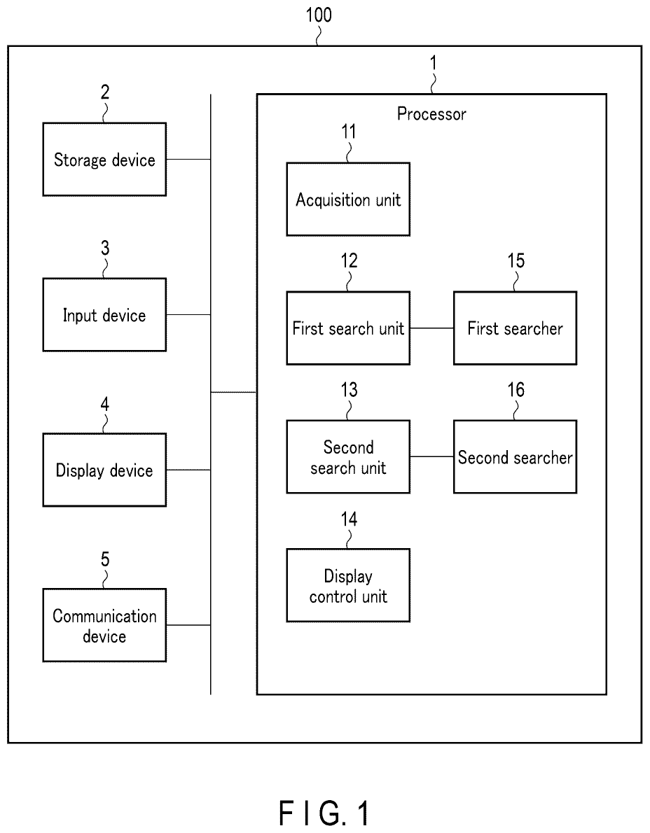

FIG. 1 is a diagram illustrating a hardware configuration example of an information processing apparatus 100. As illustrated in FIG. 1, the information processing apparatus 100 is a computer including a processor 1, a storage device 2, an input device 3, a display device 4, and a communication device 5. Transmission and reception of data and various signals among the processor 1, the storage device 2, the input device 3, the display device 4, and the communication device 5 are performed via a bus (Bus).

The processor 1 is an integrated circuit that controls the entire operation of the information processing apparatus 100. For example, the processor 1 includes a central processing unit (CPU), a graphics processing unit (GPU), a digital signal processor (DSP), and/or a floating-point unit (FPU). The processor 1 may include an internal memory or an I/O interface. The processor 1 executes various processing by interpreting and computing a program that the storage device 2 or the like stores in advance. A part or the whole of the processor 1 may be realized by hardware such as an application specific integrated circuit (ASIC) or a field programmable gate array (FPGA).

The storage device 2 is a volatile memory and/or a nonvolatile memory that stores various data. For example, the storage device 2 stores data and setting values used when the processor 1 executes various processing, data generated by various processing by the processor 1, and the like. The storage device 2 includes a read only memory (ROM), a random access memory (RAM), a hard disk drive (HDD), a solid state drive (SSD), an integrated circuit storage device, and the like. Note that the storage device 2 may include a non-transitory computer-readable storage medium that stores a program executed by the processor 1.

The input device 3 receives inputs of various operations from an operator. As the input device 3, a keyboard, a mouse, various switches, a touch pad, a touch panel display, and the like can be used. An electric signal (hereinafter, an operation signal) corresponding to the input of the received operation is supplied to the processor 1.

The display device 4 displays various data under the control of the processor 1. As the display device 4, a cathode-ray tube (CRT) display, a liquid crystal display, an organic Electro Luminescence (EL) display, a light-emitting diode (LED) display, a plasma display, or any other display can be appropriately used. The display device 4 may be a projector.

The communication device 5 includes a communication interface such as a network interface card (NIC) for performing data communication with various devices connected to the information processing apparatus 100 via a network. Note that an operation signal may be supplied from a computer connected via the communication device 5 or an input device included in the computer, or various data may be displayed on a display device or the like included in the computer connected via the communication device 5. However, in order to simplify the following description, unless otherwise specified, it is assumed that a supply source of the operation signal is the input device 3 and a target on which the various data is to be displayed is the display device 4. The input device 3 is replaceable with a computer connected via the communication device 5 or an input device included in the computer, and the display device 4 is replaceable with a display device or the like included in the computer connected via the communication device 5.

The information processing apparatus 100 does not need to include all of the processor 1, the storage device 2, the input device 3, the display device 4, and the communication device 5. A part of the storage device 2, the input device 3, the display device 4, and the communication device 5 may not be provided as necessary. The information processing apparatus 100 may be provided with any additional hardware device useful for executing the processing according to the present embodiment. The information processing apparatus 100 does not need to be physically configured by one computer, and may be configured by a computer system including a plurality of computers communicably connected via a wired, a network line or the like. The allocation of the series of processing according to the present embodiment to a plurality of processors 1 mounted on the plurality of computers can be arbitrarily set. All the processors 1 may execute all the processing in parallel, or specific processing may be assigned to one or a part of the processors 1, and the series of processing according to the present embodiment may be executed as the entire computer system.

The processor 1 solves the combinatorial optimization problem. The combinatorial optimization problem according to the present embodiment is directed to a problem seeking a discretely expressed solution that optimizes a partially differentiable objective function. As such an optimization problem, there is an Ising problem. Specifically, one of a linear regression problem, a binary classification problem, and a traveling salesman problem (TSP) is treated as the Ising problem according to the present embodiment. Here, an outline of the Ising problem will be described.

The Ising problem is a combinatorial optimization problem in which an explanation variable is composed of lattice points taking two coordination states, and an objective function is set to the Ising energy of the plurality of lattice points, and the Ising problem is a lattice model considering only two-dimensional interaction. The Ising model is one method for formulating a combination problem.

An Ising energy E_{ising} is expressed by the following equation (1). In the equation, a vector s representing a spin of each lattice takes a binary state of −1 and +1, J is a coupling coefficient matrix representing an interaction between lattices, and h is a vector representing an external magnetic field.

$${E}_{ising} = \frac{1}{2} {s}^{T} J s + h \cdot s \qquad ( 1 )$$

The Ising energy can be rewritten in a form called a quadratic unconstrained binary optimization (QUBO) problem as in the following equation (2). In the equation, a vector w takes the binary state represented by binary variables of 0 and 1.

$${E}_{ising} = {w}^{T} Q w \qquad ( 2 )$$

The equations (1) and (2) of the Ising energy are compatible with each other, and for example, Q used in the equation of QUBO can be converted into J in the following equation (4) and h in the following equation (5) by converting s into w by the following equation (3).

$$w = ( s + 1 ) / 2 \qquad ( 3 )$$

$$J = 0.5 * Q \qquad ( 4 )$$

$$h = 0. 5 * {\sum }_{i} Q \qquad ( 5 )$$

An optimization device or an optimization method that outputs the vector w or s that minimizes the Ising energy is called an Ising machine.

In the Ising problem, it is possible to extract a subproblem (sub-QUBO) by changing only a part of spins and fixing the rest of the spins. For example, when the vector w is divided into a portion w₁ to be changed and a portion w₂ to be fixed as shown in the following equation (6), since Q is a symmetric matrix, E_{ising} can be rewritten as shown in the following equation (7).

$$w = [ \begin{matrix}{w}_{1} \\ {w}_{2}\end{matrix} ] \qquad ( 6 )$$

$${E}_{ising} = {w}^{T} Qw = [ \begin{matrix}{w}_{1} & {w}_{2}\end{matrix} ] [ \begin{matrix}{Q}_{11} & {Q}_{12} \\ {Q}_{21} & {Q}_{22}\end{matrix} ] [ \begin{matrix}{w}_{1} \\ {w}_{2}\end{matrix} ] = {w}_{1}^{T} {Q}_{11} {w}_{1} + 2 \cdot ( {w}_{2}^{T} {Q}_{12} ) {w}_{1} + {w}_{2}^{T} {Q}_{22} {w}_{2} \qquad ( 7 )$$

Since w₂^{T}Q₂₂w₂ in the equation (7) is a fixed constant, E_{ising} and the subproblem E_{ising}′ in the following equation (8) can be regarded as equivalent. PGP-25E

$${E}_{ising}^{′} = {w}_{1}^{T} {Q}_{11} {w}_{1} + 2 \cdot ( {w}_{2}^{T} {Q}_{12} ) {w}_{1} \qquad ( 8 )$$

Hereinafter, a simulated bifurcation (SB) machine, which is a type of algorithm for solving the Ising problem, will be described. The following equations (9) to (13) are established between momentum y of particles according to the classical bifurcation theory, a vector x corresponding to the spin, and the Hamiltonian H.

$$\frac{{dx}_{i}}{dt} = \frac{\partial H}{\partial {y}_{i}} = {Dy}_{i} \qquad ( 9 )$$

$$\frac{{dy}_{i}}{dt} = - \frac{\partial H}{\partial {x}_{i}} = \{ - D + p ( t ) - {Kx}_{i}^{2} \} {x}_{i} + {f}_{i} \qquad ( 10 )$$

$$H = {\sum }_{i = 1}^{N} [ \frac{D}{2} ( {x}_{i}^{2} + {y}_{i}^{2} ) - \frac{p ( t )}{2} {x}_{i}^{2} + \frac{K}{4} {x}_{i}^{4} + c ( {hx}_{i} a ( t ) + \frac{1}{2} {\sum }_{j = 1}^{N} {J}_{i , j} {x}_{i} {x}_{j} ) ] \qquad ( 11 )$$

$${f}_{i} = - {cz}_{i} \qquad ( 12 )$$

$${z}_{i} = {h}_{i} a ( t ) + {\sum }_{j = 1}^{N} {J}_{i , j} {x}_{j} \qquad ( 13 )$$

A value of a coefficient p(t) monotonically increases according to the number of updates at the time of calculation. For example, p(t)=0 is set as an initial value, and p(t) monotonically increases so that p(t)=1 at the end. A coefficient a(t) increases along with p(t), and can be, for example, a(t)=√p(t). A coefficient D corresponds to detuning, and a coefficient K corresponds to a positive Kerr coefficient. Further, fᵢ is an external force, and zᵢ is a partial differentiation related to xᵢ in the last term of the Hamiltonian H. In order to ensure the accuracy of the calculation, it is also possible to set a coefficient c to a value close to a reciprocal of a maximum eigenvalue of a matrix J. For example, c=0.5·D√(N/2n) can be set. Here, N is the number of dimensions of the Ising problem, and n is an arbitrary integer.

The variable vectors x and y are treated as continuous values, and ordinary differential equations expressed by the equations (9) and (10) can be numerically solved. For example, when the symplectic Euler method is used, differential equations can be rewritten into discrete recurrence equations as expressed by the following equations (14) and (15).

$${x}_{i} ( t + Δ t ) = {x}_{i} ( t ) + {Dy}_{i} ( t ) Δ t \qquad ( 14 )$$

$${y}_{i} ( t + Δ t ) = {y}_{i} ( t ) + \{ [ - D + p ( t + Δ t ) - {Kx}_{i}^{2} ( t + Δ t ) ] {x}_{i} ( t + Δ t ) - c [ {h}_{i} a ( t + Δ t ) + {\sum }_{j = 1}^{N} {J}_{i , j} {x}_{j} ( t + Δ t ) ] \} Δ t \qquad ( 15 )$$

Here, t is time and Δt is a time step (width per time). If the time step Δt and the number of steps are set as in the equations (14) and (15), x and y can be repetitively updated. For example, it is assumed that Δt=1, and Δt may be omitted from the equations (14) and (15).

In the simulated bifurcation machine, a spin sᵢ of the Ising problem can be obtained by the sign of xᵢ after the updates reaches a predetermined number. For example, if xᵢ>0, sᵢ=+1, and if xᵢ<0, sᵢ=−1.

Therefore, in order to reduce an error, it is possible to improve the simulated bifurcation machine. Specifically, if the variable xᵢ>1 is satisfied by the update, the variable xᵢ is set to +1. Further, if xᵢ<−1 is satisfied by the update, the variable xᵢ is set to −1. This makes it possible to approximate the spin sᵢ with higher accuracy using the variable xᵢ.

Next, processing of formulating the linear regression problem to the Ising problem will be described. In the linear regression problem Y=X·β having a response variable Y, data X, and an explanation variable β, in order to obtain an estimated value β\hat{ } of β, a loss function expressed by the following equation (16) is minimized.

$$min L ( \hat{β} ) = {\vert X \hat{β} - Y \vert}^{2} = {\hat{β}}^{T} {X}^{T} X \hat{β} - 2 \hat{β} {X}^{T} Y + {Y}^{T} Y \qquad ( 16 )$$

Although β\hat{ } is a continuous value, β\hat{ } of the continuous value can be expressed by the spin s by a product of the spin s and a matrix P. Therefore, min L(β\hat{ }) of the original problem can be converted into the Ising problem of min L(s) as expressed in the following equation (17).

$$min L ( s ) = {s}^{T} {P}^{T} {X}^{T} XPs - 2 {s}^{T} {P}^{T} {X}^{T} Y \qquad ( 17 )$$

$$p = [ … , 0.0625 , 0.125 , 0.25 , 0.5 , 1. , 2. , … ]$$

$$P = [ \begin{matrix}p & & \\ & p & \\ & & ⋱\end{matrix} ]$$

$$\hat{β} \approx P \cdot s$$

Next, processing of formulating the binary classification problem to the Ising problem will be described. In the binary classification problem of predicting the response variable Y that is a categorical variable using the multidimensional data X and the explanation variable β, in order to estimate the estimated value β\hat{ } of the explanation variable β, a mediator variable b is calculated by minimizing the loss function expressed by the following equation (18). In the case there is no kernel function, the estimated value β\hat{ } can be calculated from the obtained mediator variable b according to the following equation (19).

$$min L ( b ) = \frac{1}{2} {\sum }_{n , m} {b}_{n} {b}_{m} {y}_{n} {y}_{m} {x}_{n} {x}_{m} - {\sum }_{n} {b}_{n} \qquad ( 18 )$$

$$\hat{β} = {\sum }_{i = 1} {b}_{i} {y}_{i} {X}_{i} \qquad ( 19 )$$

As in the case of formulating the linear regression problem to the Ising problem, the mediator variable b, which is a continuous value, can be represented by a binary variable w by the product of the vector w and the matrix P. The value of the mediator variable b in the binary classification problem is limited to 0≤b≤1. Therefore, min L(b) of the original problem can be converted into min L(w) of the Ising problem as expressed in the following equation (20).

$$min L ( w ) = {w}^{T} Uw - {\sum }_{i} Pw \qquad ( 20 )$$

$$U = \frac{1}{2} {( P * Y )}^{T} {X}^{T} X ( P * Y )$$

$$p = [ … , 0.0625 , 0.125 , 0.25 , 0.5 ]$$

$$P = [ \begin{matrix}p & & \\ & p & \\ & & ⋱\end{matrix} ]$$

$$\hat{b} \approx P \cdot w$$

In addition, in the case where the kernel function is used, X^{T}X in the above expression can be replaced with a gram matrix calculated based on the kernel function.

Next, processing of formulating the traveling salesman problem (TSP) to the Ising problem will be described. The traveling salesman problem is a problem of, on the assumption that a salesman goes around a plurality of cities, searching for a route along which the moving distance is the shortest. Assuming that the number of cities is N, the traveling salesman problem can be converted into a QUBO equation that solves the binary variable w in an N×N dimension expressed by the following equation (21). A vector in the kth row of the solution w indicates the visiting number by which the kth city is visited. For example, if a solution of w₁=(0, 1, 0), w₂=(1, 0, 0), and w₃=(0, 0, 1) is obtained as w in 3×3 dimensions, w means a route along which the second city is first visited, the first city is visited next, and the third city is visited last.

$${C}_{tsp} = {C}_{dist} + A \cdot {C}_{const} \qquad ( 21 )$$

$${C}_{dist} = {\sum }_{k = 1} {\sum }_{l = 1} {\sum }_{{l}^{′} = 1} {d}_{i , {l}^{′}} \cdot {w}_{k , l} \cdot {w}_{k + 1 , {l}^{′}}$$

$${C}_{const} = {\sum }_{l = 1} {( {\sum }_{k = 1} {w}_{k , l} - 1 )}^{2} + {( {\sum }_{k = 1} {w}_{k , l} - 1 )}^{2}$$

Here, C_{dist} corresponds to a moving distance, and d_{l,l′} means a relative distance between the lth and l′th cities. The two parts in a constraint term C_{const} assure that only one city is visited at the same time and that all cities are visited. Here, A is a coefficient for controlling the strength of the constraint term, and can be set to A=0.5, for example.

The processor 1 according to the present embodiment solves a combinatorial optimization problem represented by the above-described Ising problem. Specifically, the processor 1 includes functional components such as an acquisition unit 11, a first search unit 12, a second search unit 13, and a display control unit 14.

The acquisition unit 11 acquires various data related to the combinatorial optimization problem. For example, the acquisition unit 11 acquires an explanation variable, target data, and a response variable related to the combinatorial optimization problem. The explanation variable is a parameter to be updated in the combinatorial optimization problem, and the target data is a parameter to be treated as a constant that is not to be updated. The response variable is a parameter calculated based on the explanation variable and the target data. As described above, the combinatorial optimization problem according to the present embodiment is the Ising problem in which the objective function is set to the Ising energy of the plurality of lattice points. As a solution, a vector (hereinafter, the solution vector) representing a combination of a plurality of quantum states respectively corresponding to a plurality of lattice points is output. The quantum states take a binary state such as −1 and +1, 0 and +1, and 0 and −1. The solution vector has the number of dimensions corresponding to the number of lattice points. The solution vector is calculated from the explanation variable. The objective function is designed to be partially differentiable. The partial differentiation means the differentiation of the objective function related to the quantum state.

The first search unit 12 searches for a first provisional solution of the combinatorial optimization problem in which an objective function is partially differentiable, using a first search machine 15 that solves an overall problem of the combinatorial optimization problem. The overall problem is a problem to be solved for all the dimensions constituting the solution. The first provisional solution means a solution vector obtained by the first search unit 12. The first search unit 12 inputs the target data, the explanation variable, and the response variable to the first search machine 15. The first search machine 15 means an algorithm used to solve the overall problem. The first search machine 15 updates the estimated value of the explanation variable so as to optimize the objective function that is dependent on the explanation variable, the target data, and the response variable that have been input, and outputs a solution vector based on the estimated value in a case where it is evaluated that the optimization is performed. The first search unit 12 acquires the output solution vector as a first provisional solution.

The second search unit 13 outputs the final solution of the combinatorial optimization problem, based on the comparison of between signs of the first provisional solution and the partial differential value of the objective function. The final solution means a solution vector finally obtained by the second search unit 13. More specifically, the second search unit 13 extracts a first dimension from the first provisional solution, the first dimension being a dimension having a sign matching the sign of the partial differential value corresponding to the first provisional solution, and searches for the final solution, using a second search machine 16 that solves a subproblem of the combinatorial optimization problem, by computing the combinatorial optimization problem taking the first dimension as the subproblem. The subproblem is a problem to be solved only for a part of all the dimensions constituting the solution vector. Here, the partial differential value corresponding to the first provisional solution means a value obtained by substituting the quantum state corresponding to the first provisional solution into the partial differentiation of the objective function related to the quantum state. The partial differential value is expressed by a vector having a dimension corresponding to the dimension of the solution vector. The vector of the partial differential value is also referred to as a partial differential vector or a gradient vector.

If the signs of the first provisional solution and the partial differential value do not match for all the dimensions, the second search unit 13 outputs the first provisional solution as the final solution. On the other hand, if the signs of the first provisional solution and the partial differential value do not mismatch with each other in all the dimensions, the second search unit 13 extracts the first dimension from the first provisional solution. More specifically, the second search unit 13 uses the second search machine 16 to compute the combinatorial optimization problem taking the first dimension as a subproblem, and outputs a second provisional solution. The second provisional solution means a solution vector of the subproblem obtained by the second search unit 13. The solution vector of the subproblem has dimensions of the same number as dimensions of the subproblem. Specifically, the second search unit 13 inputs the explanation variable, the target data, and the response variable related to the first dimension to the second search machine 16. The second search machine 16 updates the estimated value of the explanation variable so as to optimize the objective function that is dependent on the explanation variable, the target data, and the response variable that have been input, and outputs a solution vector based on the estimated value in a case where it is evaluated that the optimization is performed. The explanation variable is updated so that the objective function is optimized, and a solution vector in a case where the objective function is optimized is output. This solution vector means the second provisional solution.

The second search unit 13 extracts a second dimension from the second provisional solution, the second dimension being a dimension having a sign matching the sign of the partial differential value corresponding to the second provisional solution, and searches for the final solution, using a second search machine 16, by computing the combinatorial optimization problem taking the second dimension as the subproblem. Here, the partial differential value corresponding to the second provisional solution means a value obtained by substituting the quantum state corresponding to the second provisional solution into the partial differentiation of the objective function related to the quantum state. The search for the final solution based on the second dimension will be described in more detail. The second search unit 13 generates an integrated solution of the second provisional solution and a remaining dimension of the first provisional solution; outputs the integrated solution as the final solution, in a case where a sign of the integrated solution and the sign of the partial differential value corresponding to the second provisional solution mismatch with each other in all dimensions, and extracts the second dimension from the second tentative solution, in a case where the sign of the integrated solution and the sign of the partial differential value corresponding to the second provisional solution fail to mismatch with each other in all dimensions. The extracted second dimension is again subjected to solving of the subproblem using the second search machine 16, and subsequent processing such as determining whether the signs match or do not match follows.

The Ising problem according to the present embodiment is one of the linear regression problem, the classification problem, and the traveling salesman problem. The first search machine 15 and the second search machine 16 are Ising machines configured to output a vector that minimizes the Ising energy which is the objective function. Each of the first search machine 15 and the second search machine 16 is a simulated annealing machine or a simulated bifurcation machine. The first search machine 15 and the second search machine 16 may be the same algorithm or different algorithms.

In the present embodiment, it is assumed that the first search machine 15 and the second search machine 16 are algorithms processed by the processor 1 of a digital computer such as the information processing apparatus 100. However, the first search machine 15 and the second search machine 16 may be implemented as hardware using a physical phenomenon. As the hardware implementation using a physical phenomenon, a quantum computer such as a quantum annealer, a coherent Ising machine, or a quantum bifurcation machine can be used. The quantum annealer implements quantum annealing using a superconducting circuit. The coherent Ising machine utilizes an oscillation phenomenon of a network formed by an optical parametric oscillator. The quantum bifurcation machine utilizes a quantum mechanical bifurcation phenomenon in a network of parametric oscillators having a Kerr effect.

The display control unit 14 displays various types of information on the display device. For example, the display control unit 14 displays the final solution.

Hereinafter, an operation of the information processing apparatus 100 according to the present embodiment will be described in detail.

First, a relationship between a sign of the solution vector and a sign of the partial differential value of the objective function will be described. In the Ising problem, the Ising energy E_{ising} is used as the objective function, and the solution vector is the spin s of each lattice. Therefore, a partial differential value, that is, the gradient vector g, of the Ising energy E_{ising}, which is the objective function, by the spin s, which is the solution vector can be expressed by the following equation (21) based on the equation (1).

$$g = \frac{{dE}_{ising}}{ds} = Js + h \qquad ( 21 )$$

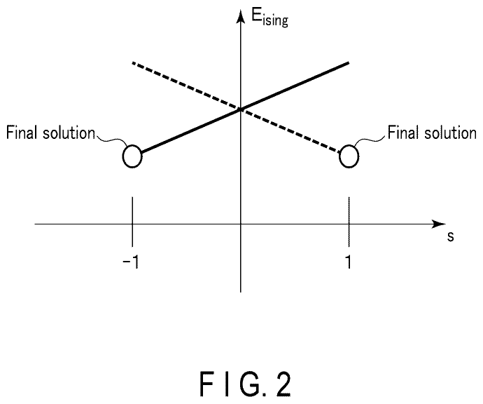

FIG. 2 is a diagram illustrating a relationship between the Ising energy E_{ising} and the spin s. In FIG. 2, the vertical axis is defined by the Ising energy E_{ising}, and the horizontal axis is defined by the spin s. A solid line in FIG. 2 represents an optimization process of the spin taking the final solution of −1, and a dotted line represents an optimization process of the spin taking the final solution of +1. As illustrated in the equation (21) and FIG. 2, since each dimension of the spin s shows a monotonous increase or a monotonous decrease, in an ideal state of optimization, the sign of the final solution s related to the same dimension and the inverse sign of the gradient vector g should match. For example, in a case of a dimension where the spin s=−1, the corresponding dimension of the gradient vector g should be +, which is the inverse sign of the spin, and therefore, in a case where the corresponding dimension is not the inverse sign, that is, in a case where the signs match, it means that the optimization for the corresponding dimension is incomplete. On the contrary, if the sign is opposite, that is, when the signs do not match, it means that the optimization for the dimension is good. The same applies to the dimension where the spin s=+1.

The reason why the dimensions having matching signs are in incomplete optimization will be described from a general Karush-Kuhn-Tucker condition. A constrained minimization problem expressed by the following equation (22) is discussed. Here, x is a variable, E(x) is a function to be minimized, and g(x) is a constraint condition.

$$minimaize E ( x ) \qquad ( 22 )$$

$$subject to g ( x ) = 0$$

In the case of the combinatorial optimization problem, since x is a binary state of −1 or +1, the constraint condition is expressed by the following equation (23).

$$g ( x ) = {x}^{2} - 1 = 0 \qquad ( 23 )$$

In this case, a stationarity condition of the final solution is expressed by the following equation (24).

$$- ∇ E ( x ) = λ \cdot ∇ g ( x ) = λ \cdot 2 x \qquad ( 24 )$$

If x in the equation (24) is replaced with the spin s, the same conclusion as that of the gradient equation (21) of the Ising energy is obtained. Therefore, it can be understood from the Karush-Kuhn-Tucker condition that “the sign of the final solution s and the inverse sign of the gradient vector g should match”.

On the premise of this understanding, the second search unit 13 compares the sign of the solution of the objective function with the sign of the partial differential value, extracts a dimension having the same sign as a dimension of incomplete optimization, and optimizes the extracted dimension again as a subproblem.

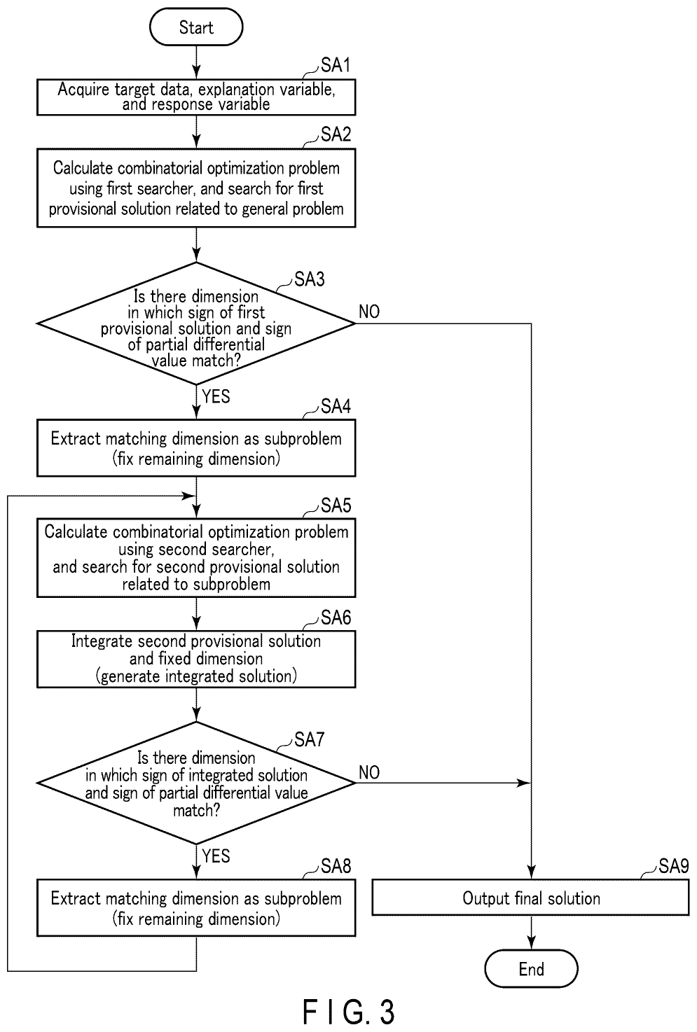

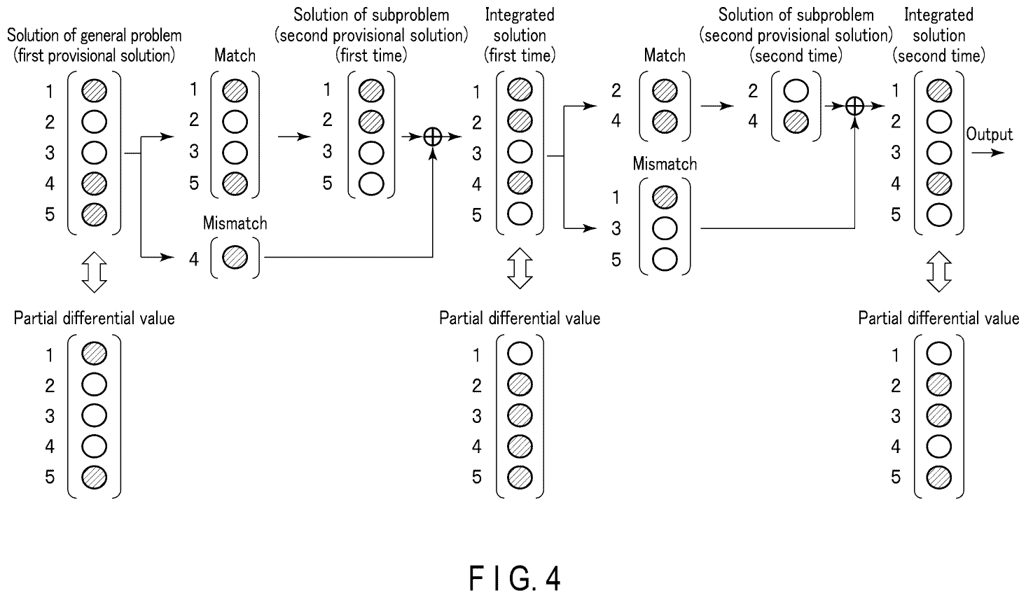

Next, a processing procedure of the optimization processing by the processor 1 will be described. FIG. 3 is a diagram illustrating by an example the processing procedure of the optimization processing. FIG. 4 is a diagram schematically illustrating a transition between a sign of the solution and a sign of the partial differentiation in the optimization processing shown in FIG. 3. In FIG. 4, for convenience of description, the solution vector and the partial differential value are assumed to be five-dimensional vectors. Hatched circles in each vector indicate dimensions of the sign +, and non-hatched circles indicate dimensions of the sign −.

As illustrated in FIG. 3, the acquisition unit 11 acquires the target data, the explanation variable, and the response variable (step SA1). The numbers of dimensions and the sample sizes of the target data and the explanation variable are the same. The numbers of dimensions and the sample sizes can be set to any number.

As an example, processing in step SA1 in a case where the linear regression problem is solved by the Ising problem will be described. The acquisition unit 11 randomly generates target data X of 1000 dimensions×the sample size 2000 from a normal distribution with an average of 0 and a variance of 1. In addition, the acquisition unit 11 randomly generates an explanation variable β having 1000 dimensions which is the same number of dimensions as the target data X from a normal distribution with an average of 0 and a variance of 0.5. The acquisition unit 11 selects the explanation variable β whose absolute value does not exceed 1. The acquisition unit 11 calculates the response variable Y according to Y=X·β. The acquisition unit 11 converts the explanation variable β of the linear regression problem into the vector s of the spin using a conversion equation expressed by the following equation (25). Here, p is obtained by scaling a sequence of 1, 2, 4, 8, 16, . . . to an appropriate threshold.

$$\overbrace{β} = [ \begin{matrix}p & & \\ & p & \\ & & ⋱\end{matrix} ] \cdot s \qquad ( 25 )$$

$$p = [ 0.00390625 , 0.0078125 , 0.015625 , 0.03125 , 0.0625 , 0.125 , 0.25 , 0.5 ]$$

As another example, processing in step SA1 in a case where the binary classification problem is solved by the Ising problem will be described. The acquisition unit 11 randomly generates data X of 100 dimensions×the sample size 2000 from a normal distribution with an average of 0 and a variance of 1. The acquisition unit 11 randomly generates the explanation variable β having 100 dimensions which is the same number of dimensions as the target data X from a normal distribution with an average of 0 and a variance of 1. The acquisition unit 11 calculates the response variable Y according to Y=X·β. The acquisition unit 11 sets Y=1 if Y>0, and sets Y=−1 if Y<0. The acquisition unit 11 converts the mediator variable b of the binary classification problem into the binary vector w using a conversion equation expressed by the following equation (26). Here, p is obtained by scaling a sequence of 1, 2, 4, 8, 16, . . . to an appropriate threshold.

$$\overbrace{b} = [ \begin{matrix}p & & \\ & p & \\ & & ⋱\end{matrix} ] \cdot w \qquad ( 26 )$$

$$p = [ 0.00390625 , 0.0078125 , 0.015625 , 0.03125 , 0.0625 , 0.125 , 0.25 , 0.5 ]$$

Upon execution of step SA1, the first search unit 12 searches for the first provisional solution related to the overall problem, using the first search machine 15, by computing a combinatorial optimization problem (step SA2). The Ising problem according to the present embodiment is one of the linear regression problem, the binary classification problem, and the traveling salesman problem. The first search machine 15 is an Ising machine configured to output a vector that minimizes the Ising energy. The first search machine 15 is the simulated annealing machine or the simulated bifurcation machine. In the case where the simulated bifurcation machine is used, a detuning coefficient D, a Kerr coefficient K, and a coefficient c shown in equations (9) to (12) are preferably set to D=1, K=0, and c=D/(2σ·√n), respectively. Here, N is the number of dimensions of the Ising problem, and σ is the standard deviation value of all elements of the matrix J in the Ising problem.

Specifically, the first search machine 15 calculates the objective function value based on the target data, the explanation variable, and the response variable acquired in step SA1, and updates the explanation variable so that the objective function value is minimized. The first search machine 15 repeats the calculation of the objective function value and the update of the explanation variable until a predetermined stop condition is satisfied. The predetermined stop condition can be set to, for example, that the number of calculation steps exceeds a threshold, that the objective function value or the explanation variable value exceeds a predetermined value, or the like. Then, if a predetermined stop condition is satisfied, the first search machine 15 outputs, as a first provisional solution, a solution vector corresponding to the objective function value in the calculation step when the condition is satisfied. Here, the calculation step means a processing step in which each of the calculation of the objective function value and the update of the explanation variable are performed once.

For example, in a case where a simulated bifurcation machine is used as the first search machine 15, the first search machine 15 executes a product-sum operation of a coupling coefficient matrix of the Ising problem and the vector, and update of the vector based on a result of the product-sum operation until the number of calculation steps exceeds a predetermined number. When the number of times of performing the product-sum operation and the update of the vector exceeds a predetermined number of calculation steps, the first search machine 15 outputs the vector in the calculation step when the number of times exceeds the predetermined number of calculation steps as the first provisional solution. In this case, the number of calculation steps for solving the combinatorial optimization problem may be set to a value proportional to the number of dimensions of the Ising problem, or may be set to the number of steps determined by the user or the like.

Upon execution of step SA2, the second search unit 13 determines whether there is a dimension in which the sign of the first provisional solution obtained in step SA2 matches the sign of the partial differential value (step SA3). Specifically, the second search unit 13 calculates the partial differential value by substituting the first provisional solution for the partial differentiation of the objective function at the spin. The partial differential value has the same number of dimensions as the first provisional solution (spin). Then, the second search unit 13 compares the sign of the calculated partial differential value with the sign of the first provisional solution obtained in step SA2 for each same dimension. A dimension whose signs match is an incomplete optimization dimension, and a dimension whose signs do not match is a complete optimization dimension.

In the case of the linear regression problem, the objective function is a loss function L(s) shown in the equation (17), and the partial differentiation dL(s)/ds of the loss function L(s) related to the spin s is used as the partial differentiation. In the case of the binary classification problem, the objective function is a loss function L(w) shown in the equation (19), and the partial differentiation dL(w)/dw of the loss function L(w) related to the binary variable w is used as the partial differentiation. In the case of the traveling salesman problem, the objective function is a cost function C_tsp (w) shown in the equation (20), and the partial differentiation dC_tsp (w)/dw of the cost function C_tsp (w) related to the binary variable w is used as the partial differentiation.

If it is determined that there is no dimension in which the sign of the first provisional solution and the sign of the partial differential value match (step SA3: NO), the second search unit 13 outputs the first provisional solution as the final solution since the entire dimension of the first provisional solution obtained in step SA2 is the mismatching dimension and the complete optimization dimension (step SA9).

On the other hand, if it is determined in step SA3 that there is a dimension in which the sign of the first provisional solution matches the sign of the partial differential value (step SA3: YES), the second search unit 13 extracts the matching dimension as a subproblem from the first provisional solution (step SA4). For example, as illustrated in FIG. 4, the signs of the first provisional solution and the partial differential value are compared for each dimension. In a case where the signs of the first, fourth, and fifth dimensions of the first provisional solution are +, the signs of the second and third dimensions are −, the signs of the first and fifth dimensions of the partial differentiation are +, and the signs of the second to fourth dimensions are −, the first, second, third, and fifth dimensions among the dimensions constituting the first provisional solution are extracted as matching dimensions (incomplete optimization dimensions). The remaining fourth dimension is fixed as a mismatching dimension (complete optimization dimension).

Upon execution of step SA4, the second search unit 13 searches for the second provisional solution related to the subproblem, using the second search machine 16, by computing a combinatorial optimization problem (step SA5). Similarly to the first search machine 15, the second search machine 16 is an Ising machine, and is a simulated annealing machine or a simulated bifurcation machine.

Specifically, the second search unit 13 calculates the objective function value based on the target data, the explanation variable, and the response variable related to the matching dimension, and updates the explanation variable so that the objective function value is minimized. The second search unit 13 repeats the calculation of the objective function value and the update of the explanation variable until a predetermined stop condition is satisfied. The predetermined stop condition can be set to the same content as the stop condition in the overall problem. Then, if a predetermined stop condition is satisfied, the second search unit 13 outputs, as a second provisional solution for the first time, a solution vector corresponding to the objective function value in the calculation step when the condition is satisfied. The second provisional solution is a solution vector having the matching dimensions of the number extracted in step SA4.

In a case where the simulated bifurcation machine is used as the second search machine 16, the second search machine 16 executes a product-sum operation of the coupling coefficient matrix of the Ising problem and the vector and update of the vector based on a result of the product-sum operation until the number of calculation steps exceeds a predetermined number. When the number of times of performing the product-sum operation and the update of the vector exceeds a predetermined number of calculation steps, the second search machine 16 outputs the vector in the calculation step when the number of times exceeds the predetermined number of calculation steps as the second provisional solution for the first time. In this case, the number of calculation steps for solving the combinatorial optimization problem may be set to a value proportional to the number of dimensions of the Ising problem, or may be set to the number of steps determined by the user or the like.

Upon execution of step SA5, the second search unit 13 integrates the second provisional solution obtained in step SA5 and the mismatching dimension (complete optimization dimension) fixed in step SA4 (step SA6). In the example of FIG. 4, in a case where the second provisional solution for the first time is constituted by the first to third and fifth dimensions and the completely optimized dimension is constituted by the fourth dimension, a five-dimensional integrated solution for the first time having the same number of dimensions as the first provisional solution is generated by integrating the second provisional solution and the mismatching dimension. Since the mismatching dimension is not used for the subproblem, there is no sign change from the first provisional solution.

Upon execution of step SA6, the second search unit 13 determines whether there is a dimension in which the sign of the integrated solution obtained in step SA6 matches the sign of the partial differential value (step SA7). Specifically, the second search unit 13 calculates the partial differential value by substituting the integrated solution based on the second provisional solution and the mismatching dimension for the partial differentiation of the objective function at the spin. Since the partial differential value obtained in step SA7 is calculated again based on the integrated solution, both the matching dimension and the mismatching dimension may have different signs with respect to the partial differential value obtained in step SA3. The second search unit 13 compares the sign of the calculated partial differential value with the sign of the integrated solution obtained in step SA6 for each same dimension.

If it is determined in step SA7 that there is a dimension in which the sign of the integrated solution matches the sign of the partial differential value (step SA7: YES), the second search unit 13 extracts the matching dimension as a subproblem (step SA8). For example, as illustrated in FIG. 4, the signs of the integrated solution for the first time and the partial differential value are compared for each dimension. In a case where the signs of the first, second, and fourth dimensions of the integrated solution for the first time are +, the signs of the third and fifth dimensions are −, the sign of the first dimension of the partial differentiation is +, and the signs of the second to fifth dimensions are −, the second and fourth dimensions among the dimensions constituting the integrated solution are extracted as matching dimension (incomplete optimization dimension). The remaining first, third, and fifth dimensions are fixed as mismatching dimensions (complete optimization dimensions).

Thereafter, the second search unit 13 executes steps SA5 to SA7 taking the mismatching dimension extracted in step SA8 as a subproblem, and repeats steps SA5 to SA8 until it is determined in step SA7 that there is no dimension in which the sign of the integrated solution and the sign of the partial differential value match. In the example of FIG. 4, the subproblem is computed for the matching dimension extracted from the integrated solution for the first time, and the second provisional solution for the second time is obtained. An integrated solution for the second time is generated based on the second provisional solution for the second time and the mismatching dimension extracted from the integrated solution for the first time. The integrated solution for the second time and the partial differential value based on the integrated solution for the second time are compared for each dimension. In the case of the example of FIG. 4, the signs of the integrated solution for the second time and the partial differential value do not match in all the dimensions. Note that, in a case where the integrated solution for the second time has a matching dimension with the partial differential value, steps SA4 to SA7 are executed taking the mismatching dimension as a subproblem, and steps SA5 to SA8 are repeated until it is determined in step SA7 that there is no dimension in which the sign of the integrated solution and the sign of the partial differential value match.

Then, if it is determined in step SA7 that there is no dimension in which the sign of the integrated solution and the sign of the partial differentiation match (step SA7: NO), the second search unit 13 outputs the integrated solution obtained in step SA6 as the final solution (step SA9). The final solution can be displayed in an arbitrary layout by the display control unit 14. The display target is not limited only to the final solution, and the first provisional solution and the second provisional solution may be displayed in an arbitrary layout such as a graph.

As described above, the optimization processing according to the present embodiment ends.

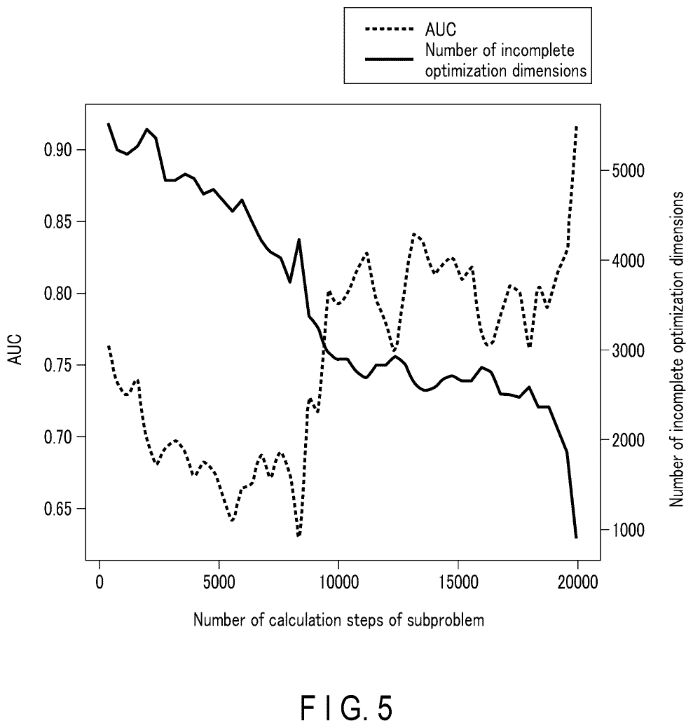

FIG. 5 is a diagram for comparing prediction accuracy and the number of matching dimensions (incomplete optimization dimensions) in a case where a binary classification problem is solved by a simulated bifurcation algorithm. The left vertical axis in FIG. 5 is defined as an area under curve (AUC) which is an example of prediction accuracy, the right vertical axis is defined as the number of incomplete optimization dimensions, and the horizontal axis is defined as the number of calculation steps. The upper limit of the number of calculation steps was set to 20,000. The number of calculation steps of the subproblem means the number of execution of the determination processing in step SA7, in other words, the number of execution of the repetitive processing from steps SA4 to SA8. As illustrated in FIG. 5, there is a tendency that the prediction accuracy is improved as the number of calculation steps of the subproblem increases, and that the number of incomplete optimization dimensions decreases. Therefore, by setting the overall problem to a small number of calculation steps, and performing optimization again using the incomplete optimization dimension as a subproblem, it is possible to expect improvement in lack of accuracy and improvement in calculation efficiency.

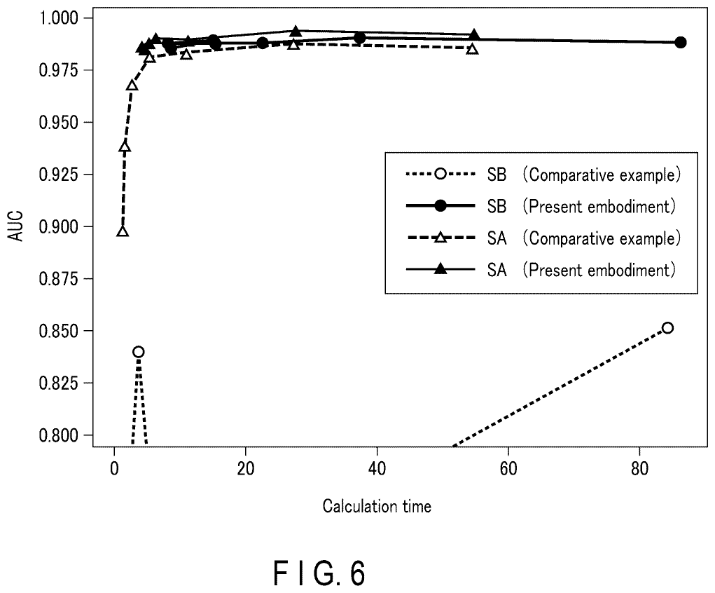

FIG. 6 is a diagram for comparing prediction accuracy between the present embodiment and a comparative example in a case where the binary classification problem is solved by the simulated bifurcation machine (SB) and the simulated annealing machine (SA). In FIG. 6, the vertical axis is defined as AUC which is an example of prediction accuracy, and the horizontal axis is defined as calculation time. The comparative example is an example in which only the overall problem is calculated. In the case of the comparative example, the prediction accuracy was calculated for each calculation step of the overall problem for each of SB and SA. In the case of the present embodiment, for each of SB and SA, after the overall problem was calculated in the same manner as in the comparative example, the subproblem was additionally calculated, and the prediction accuracy was calculated for each calculation step of the subproblem. In the present embodiment, the total time of the calculation time of the overall problem and the calculation time of the subproblem were taken as the calculation time. In the case of SB of the present embodiment, the overall problem was solved by SB, and then the subproblem was recalculated by SB. The number of calculation steps for the subproblem was fixed at 50. In the case of SA of the present embodiment, the overall problem was solved by SA, and then the subproblem was recalculated by SA. The number of calculation steps of the subproblem was proportional to the number of dimensions of the subproblem. As illustrated in FIG. 6, with both SB and SA, in the present embodiment, it was possible to obtain better prediction accuracy and calculation efficiency than in the comparative example. It can also be seen that this tendency is particularly remarkable in the case of SB.

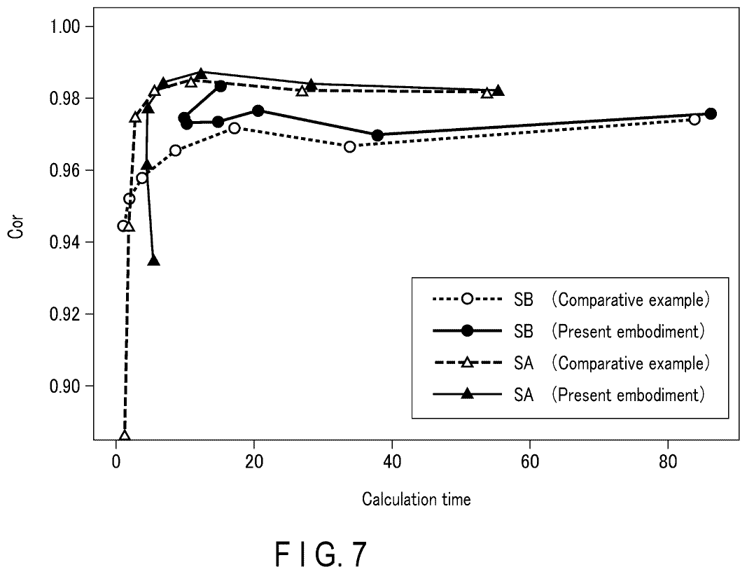

FIG. 7 is a diagram for comparing prediction accuracy between the present embodiment and a comparative example in a case where the linear regression problem is solved by the simulated bifurcation machine (SB) and the simulated annealing machine (SA). In FIG. 7, the vertical axis is defined by Cor (correlation coefficient) which is an example of prediction accuracy, and the horizontal axis is defined as calculation time. The processing procedures of the present embodiment and the comparative example are similar to that of FIG. 6. As illustrated in FIG. 7, regarding the linear regression problem, with both SB and SA, in the present embodiment, it was possible to obtain better prediction accuracy and calculation efficiency than in the comparative example.

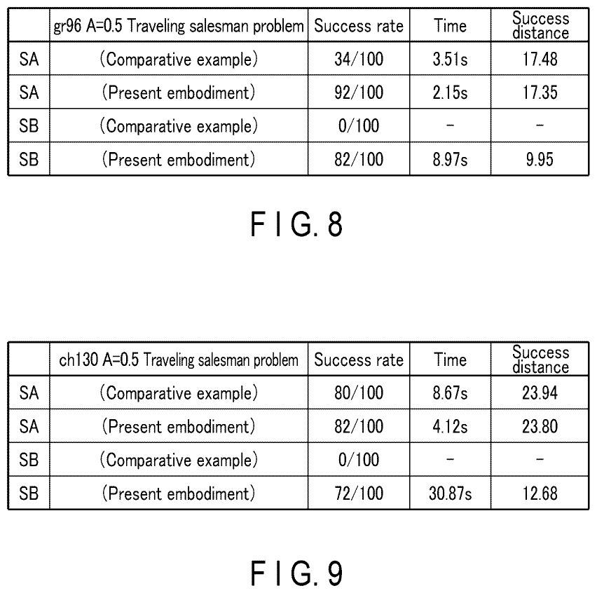

FIGS. 8 and 9 are diagrams for comparing prediction accuracy between the present embodiment and a comparative example in a case where a traveling salesman problem is solved by a simulated bifurcation machine (SB) and a simulated annealing machine (SA). FIG. 8 illustrates an example in which 96 cities in Groetschel, Africa are applied to the traveling salesman problem (gr96), and FIG. 9 illustrates an example in which 130 cities in Churritz are applied to the traveling salesman problem (ch130). In gr96, the binary variable of 96×96 dimensions is set to the Ising problem that solves the binary variable of 130×130 dimensions in ch130. A coefficient A for controlling the intensity of the constraint term at the time of converting the traveling salesman problem into the Ising problem, which is shown in the equation (20), is set to A=0.5. For both SB and SA, the number of calculation steps for the overall problem was set to a fixed value. The number of execution was set to 100, and a success rate (probability that the constraint term is satisfied), time (average calculation time), and the success distance (average moving distance in a case of success) of the solution were calculated. In the case of SB of the present embodiment, the overall problem was solved by SB, and then the subproblem was calculated by SA. The number of calculation steps of the subproblem was proportional to the number of dimensions of the subproblem. In the case of SA of the present embodiment, after the overall problem was approximately solved by SA with a smaller number of calculation steps than usual, the subproblem was also calculated by SA. The number of calculation steps of the subproblem was proportional to the number of dimensions of the subproblem.

As illustrated in FIGS. 8 and 9, in the case of the SA of the present embodiment, the success rate was improved and the calculation time was reduced as compared with the SA of the comparative example, but the moving distance was almost the same. In the case of SB of the present embodiment, the success rate was remarkably improved as compared with SB of the comparative example. In addition, a solution having a shorter moving distance than that of the SA is obtained.

The processing procedure of the optimization processing illustrated in FIG. 3 is an example, and the present embodiment is not limited thereto, and various elements can be deleted, added, and/or changed.

As an example, in the processing illustrated in FIG. 3, the end condition of the repetition of steps SA4 to SA8 is a case where the sign of the integrated solution and the sign of the partial differential value match in all dimensions. However, the present embodiment is not limited thereto. The end condition of the repetition of steps SA4 to SA8 may be set to, for example, a case where a scale of the extracted subproblem does not change, a case where the number of calculation steps reaches a threshold value, a case where the number of matching dimensions is equal to or less than a threshold value, or a case where the prediction accuracy reaches a threshold value.

In the above embodiment, the second search unit 13 extracts an incomplete optimization dimension from the first provisional solution, and searches for a final solution by computing the combinatorial optimization problem using the incomplete optimization dimension as a subproblem. However, the present embodiment is not limited thereto. As another example, a second search unit 13 may extract a first dimension (incomplete optimization dimension) from the first provisional solution, the first dimension being a dimension having a sign matching the sign of the partial differential value corresponding to the first provisional solution; generate a second dimension by setting the sign of the first dimension to an opposite sign; generate an integrated solution of the second dimension and a remaining dimension of the first provisional solution; and output the integrated solution as the final solution. In this case, a second search machine 16 is unnecessary. Hereinafter, a processing procedure of the present modification will be described. Note that, in the following description, components having substantially the same functions as those of the above embodiment will be denoted by the same reference numerals, and redundant description will be given only when necessary.

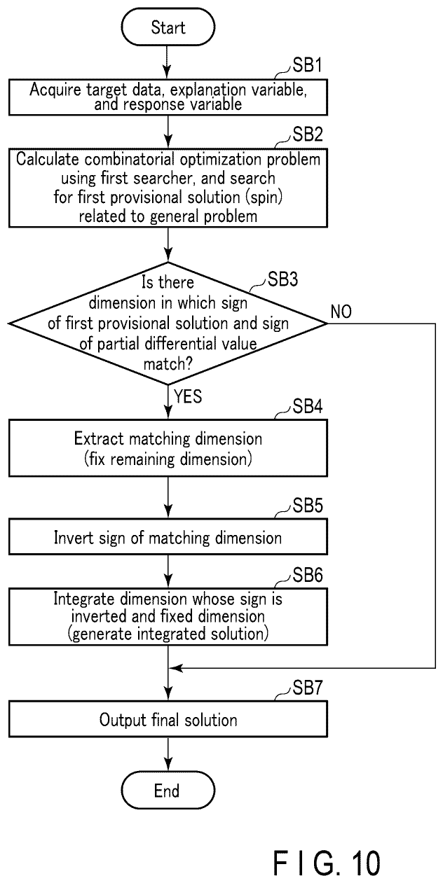

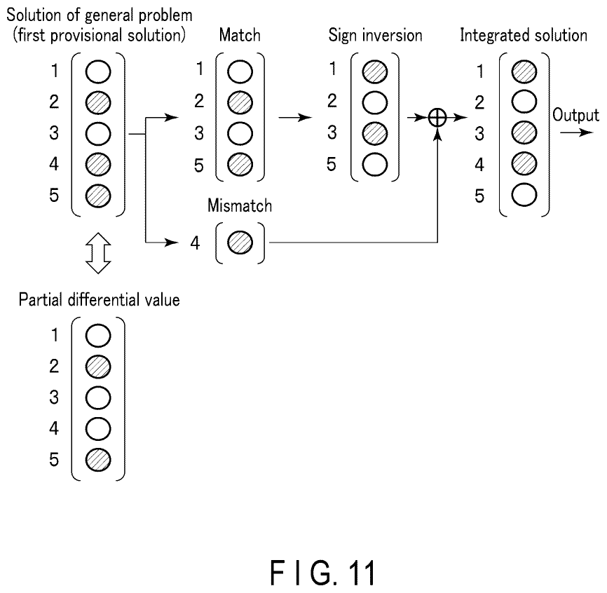

FIG. 10 is a diagram illustrating by an example a processing procedure of the optimization processing according to the modification. FIG. 11 is a diagram schematically illustrating a transition between a sign of a solution and a sign of a partial differential value in the optimization processing shown in FIG. 10. In FIG. 11, similarly to FIG. 4, for convenience of description, the solution vector and the partial differential value are assumed to be five-dimensional vectors. Hatched circles in each vector indicate dimensions of the sign +, and non-hatched circles indicate dimensions of the sign −.

As illustrated in FIG. 10, first, an acquisition unit 11 acquires target data and the like (step SB1), a first search unit 12 obtains a first provisional solution related to the overall problem (step SB2), and determines whether the sign of the first provisional solution matches or does not match the sign of the partial differential value (step SB3). Steps SB1, SB2, and SB3 are similar to steps SA1, SA2, and SA3 in FIG. 3, respectively, and description thereof is omitted.

In a case where it is determined in step SB3 that there is no dimension in which the sign of the first provisional solution and the sign of the partial differential value match (step SB3: NO), the second search unit 13 outputs the first provisional solution as the final solution since all dimensions of the first provisional solution obtained in step SB2 are the mismatching dimensions and the complete optimization dimensions (step SB7).

If it is determined in step SB3 that there is a dimension in which the sign of the first provisional solution matches the sign of the partial differential value (step SB3: YES), the second search unit 13 extracts the matching dimension from the first provisional solution (step SB4). For example, as illustrated in FIG. 11, the signs of the first provisional solution and the partial differential value are compared for each dimension. In a case where the signs of the second, fourth, and fifth dimensions of the first provisional solution are +, the signs of the first and third dimensions are −, the signs of the second and fifth dimensions of the partial differential value are +, and the signs of the first, third, and fourth dimensions are −, the first, second, third, and fifth dimensions among the dimensions constituting the first provisional solution are extracted as matching dimensions (incomplete optimization dimensions). The remaining fourth dimension is fixed as a mismatching dimension (complete optimization dimension).

Upon execution of step SB4, the second search unit 13 inverts the sign of the matching dimension extracted in step SB4 (step SB5), and integrates the matching dimension after the sign inversion obtained in step SB5 and the mismatching dimension fixed in step SB4 (step SB6). For example, as illustrated in FIG. 11, in step SB5, the signs of the first and third dimensions that are the matching dimensions are inverted from − to +, and the signs of the second and fifth dimensions are inverted from + to −, and the matching dimensions after the sign inversion is obtained. Then, by integrating the mismatching dimension, which is the fourth dimension, into the mismatching dimensions, a five-dimensional integrated solution is generated. From the sign operation, the sign of the integrated solution and the sign of the partial differential value do not match in all the dimensions.

Upon execution of step SB6, the second search unit 13 outputs the integrated solution generated in step SB6 as the final solution (step SB7). The final solution can be displayed in an arbitrary layout by the display control unit 14. The display target is not limited only to the final solution, and the first provisional solution may be displayed in an arbitrary layout.

As described above, the optimization processing according to the modification ends.

According to the modification, since the optimization computing of the subproblem is not performed as compared with the optimization processing illustrated in FIG. 3, the calculation time required to obtain the final solution is shortened. In addition, since the sign of the matching dimension (incomplete optimization dimension) is inverted, improvement in the prediction accuracy of the final solution is expected as compared with a case where only the overall problem is performed.

Note that the optimization processing illustrated in FIG. 3 and the optimization processing illustrated in FIG. 10 can be combined. For example, in the optimization processing illustrated in FIG. 3, if it is determined in step SA7 that the number of calculation steps exceeds the threshold value and there is a dimension in which the sign of the integrated solution and the sign of the partial differential value match (step SA7: YES), the processing in and after step SB4 illustrated in FIG. 10 may be performed. The threshold value can be set to any value of 1 or more. Alternatively, in the optimization processing illustrated in FIG. 3, if it is determined in step SA7 that the number of calculation steps exceeds the threshold value and there is a dimension in which the sign of the integrated solution and the sign of the partial differential value match (step SA7: YES), a user may select whether to continue to perform steps SA5 to SA8 illustrated in FIG. 3 or to perform the processing of step SB4 and subsequent steps illustrated in FIG. 10.

As described above, an information processing apparatus 100 according to the present embodiment includes a processor 1. The processor 1 searches for a first provisional solution of the combinatorial optimization problem in which an objective function is partially differentiable, using a first search machine 15 that solves an overall problem of the combinatorial optimization problem. The processor 1 outputs the final solution of the combinatorial optimization problem, based on the comparison of between signs of the first provisional solution and the partial differential value of the objective function.

According to the above configuration, even when a good solution cannot be obtained for the overall problem, the accuracy of the final solution can be improved. In addition, if the number of times of calculation of the overall problem is reduced, the accuracy of the final solution can be maintained at the same level as in the related art.

Thus, it is possible to improve the calculation accuracy and/or to reduce the processing time of the combinatorial optimization problem.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising
a processor configured to execute:
first search processing of searching for a first provisional solution of a combinatorial optimization problem in which an objective function is partially differentiable, using a first search machine that solves an overall problem of the combinatorial optimization problem; and
a second search processing of outputting a final solution of the combinatorial optimization problem based on a comparison between signs of the first provisional solution and a partial differential value of the objective function.

2. The information processing apparatus according to claim 1, wherein
in the second search processing, the processor:
extracts a first dimension from the first provisional solution, the first dimension being a dimension having a sign matching the sign of the partial differential value corresponding to the first provisional solution; and
searches for the final solution, using a second search machine that solves a subproblem of the combinatorial optimization problem, by computing the combinatorial optimization problem taking the first dimension as the subproblem.

3. The information processing apparatus according to claim 2, wherein
in the second search processing, the processor:
outputs the first provisional solution as the final solution, in a case where the signs of the first provisional solution and the partial differential value mismatch with each other in all dimensions; and
extracts the first dimension from the first provisional solution, in a case where the signs of the first provisional solution and the partial differential value fail to mismatch with each other in all dimensions.

4. The information processing apparatus according to claim 3, wherein
in the second search processing, the processor:
outputs a second provisional solution, using the second search machine, by computing the combinatorial optimization problem taking the first dimension as the subproblem;
extracts a second dimension from the second provisional solution, the second dimension being a dimension having a sign matching the sign of the partial differential value corresponding to the second provisional solution; and
searches for the final solution, using the second search machine, by computing the combinatorial optimization problem taking the second dimension as the subproblem.

5. The information processing apparatus according to claim 4, wherein
in the second search processing, the processor:
generates an integrated solution of the second provisional solution and a remaining dimension of the first provisional solution;
outputs the integrated solution as the final solution, in a case where a sign of the integrated solution and the sign of the partial differential value corresponding to the second provisional solution mismatch with each other in all dimensions; and
extracts the second dimension from the second tentative solution, in a case where the sign of the integrated solution and the sign of the partial differential value corresponding to the second provisional solution fail to mismatch with each other in all dimensions.

6. The information processing apparatus according to claim 2, wherein
the combinatorial optimization problem is an Ising problem for outputting a vector representing a combination of quantum states of a plurality of lattice points as the first provisional solution and the final solution, the objective function being set to an Ising energy of the plurality of lattice points,
the quantum states are binary states, and
the partial differentiation of the objective function is differentiation of the objective function related to the quantum states.

7. The information processing apparatus according to claim 6, wherein the Ising problem is one of a linear regression problem, a support vector machine classification problem, and a traveling salesman problem.

8. The information processing apparatus according to claim 6, wherein the first search machine and the second search machine are an Ising machine that outputs the vector for minimizing the Ising energy.

9. The information processing apparatus according to claim 8, wherein each of the first search machine and the second search machine is a simulated annealing machine or a simulated bifurcation machine.

10. The information processing apparatus according to claim 9, wherein in a case where each of the first search machine and the second search machine is the simulated bifurcation machine, a number of calculation steps for solving the combinatorial optimization problem by the first search machine and/or the second search machine is set to a value proportional to a number of dimensions of the Ising problem.

11. The information processing apparatus according to claim 6, wherein the first search machine and/or the second search machine executes: a product-sum operation of a coupling coefficient matrix of the Ising problem and the vector, and update of the vector based on a result of the product-sum operation, until a number of calculation steps exceeds a predetermined number; and outputs, if the number of execution of the product-sum operation and the update exceeds the predetermined number of calculation steps, the vector in a calculation step in a case where the number of calculation steps exceeds the predetermined number as the first provisional solution and/or the final solution.

12. The information processing apparatus according to claim 1, wherein
in the second search processing, the processor:
extracts a first dimension from the first provisional solution, the first dimension being a dimension having a sign matching the sign of the partial differential value corresponding to the first provisional solution;
generates a second dimension by setting the sign of the first dimension to an opposite sign;
generates an integrated solution of the second dimension and a remaining dimension of the first provisional solution; and
outputs the integrated solution as the final solution.

13. An information processing method comprising:
searching for a first provisional solution of a combinatorial optimization problem in which an objective function is partially differentiable, using a first search machine that solves an overall problem of the combinatorial optimization problem; and
outputting a final solution of the combinatorial optimization problem based on a comparison between signs of the first provisional solution and a partial differential value of the objective function.

14. A non-transitory computer readable storage medium including computer executable instructions, wherein the instructions, when executed by a processor, cause the processor to perform operations comprising:
searching for a first provisional solution of a combinatorial optimization problem in which an objective function is partially differentiable, using a first search machine that solves an overall problem of the combinatorial optimization problem; and
outputting a final solution of the combinatorial optimization problem based on a comparison between signs of the first provisional solution and a partial differential value of the objective function.
